(19) United States
(12) Patent Application Publication
(10) Pub. No.: US 2024/0142675 A1
(43) Pub. Date: May 2, 2024

(54) OPTICAL APPARATUS AND ITS CONTROL METHOD

(71) Applicant: CANON KABUSHIKI KAISHA, Tokyo (JP)

(72) Inventor: AKIRA SATO, Kanagawa (JP)

(21) Appl. No.: 18/490,251

(22) Filed: Oct. 19, 2023

(30) Foreign Application Priority Data
Oct. 28, 2022 (JP) 2022-173158

(51) Int. Cl. G02B 5/00

(52) U.S. Cl. CPC G02B 5/005

(57) ABSTRACT

An optical apparatus includes an aperture unit having a variable aperture value, an operation member operable by a user and configured to set the aperture value, and a processor configured to output a specified aperture value according to an operation of the operation member, generate a target aperture value from the specified aperture value, and control driving of the aperture unit based on the target aperture value. The processor performs one of first processing for generating the target aperture value with a first resolution from the specified aperture value, and second processing for generating the target aperture value with a second resolution, which is finer than the first resolution, from the specified aperture value.

### BACKGROUND

### Technical Field

One of the aspects of the embodiments relates to an optical apparatus that can drive an aperture stop according to an operation on an operation member.

### Description of Related Art

Japanese Patent Laid-Open No. 2012-53271, for example, discloses an optical apparatus having an operation member (aperture ring) for specifying a setting value of an aperture stop. In such an optical apparatus, the user can specify an aperture value (F-number) by operating the aperture ring so as to align an index provided on the aperture ring with an index for each aperture value provided near the aperture ring. In another optical apparatus, a sensor detects a rotation position (or a rotation amount) of an electronic ring type aperture ring, a motor mounted on an electromagnetic aperture stop is driven according to a detected rotation position, and an aperture value (aperture diameter) is adjusted.

In a case where the electronic ring type aperture ring is used, the response of the aperture value (aperture diameter) control of the electromagnetic aperture stop to the operation of the aperture ring becomes smooth by increasing (making finer) the detecting resolution of the rotation position of the aperture ring and the driving resolution of the electromagnetic aperture stop. As a result, a moving image with smooth changes in luminance can be acquired, especially during moving image capturing.

However, the fine detecting resolution of the rotation position of the aperture ring may cause the electromagnetic aperture stop to be driven by minute changes in the rotation position of the aperture ring, and the aperture value may have an error. As a result, the aperture value accuracy may be lowered particularly in still image capturing, and a still image with desired luminance may not be able to be obtained.

### SUMMARY

An optical apparatus according to one aspect of the embodiment includes an aperture unit having a variable aperture value, an operation member operable by a user and configured to set the aperture value, and a processor configured to output a specified aperture value according to an operation of the operation member, generate a target aperture value from the specified aperture value, and control driving of the aperture unit based on the target aperture value. The processor performs one of first processing for generating the target aperture value with a first resolution from the specified aperture value, and second processing for generating the target aperture value with a second resolution, which is finer than the first resolution, from the specified aperture value. A control method of the above optical apparatus also constitutes another aspect of the embodiment.

Further features of the disclosure will become apparent from the following description of embodiments with reference to the attached drawings.

### BRIEF DESCRIPTION OF THE DRAWINGS

FIG. 1 is a block diagram illustrating a configuration of an interchangeable lens and a camera body according to Example 1.

FIG. 2 illustrates the overview of an aperture ring and its surroundings in the interchangeable lens according to Example 1.

FIGS. 3A and 3B illustrate a structure of stored data of a position of the aperture ring according to Example 1.

FIG. 4 is a flowchart illustrating aperture control processing according to Example 1.

FIG. 5 is a flowchart illustrating aperture index value determining processing according to Example 1.

FIG. 6 is a flowchart illustrating aperture index value determining processing according to Example 2.

FIG. 7 is a flowchart illustrating aperture index value determining processing according to Example 3.

FIG. 8 is a flowchart illustrating aperture index value determining processing according to Example 4.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

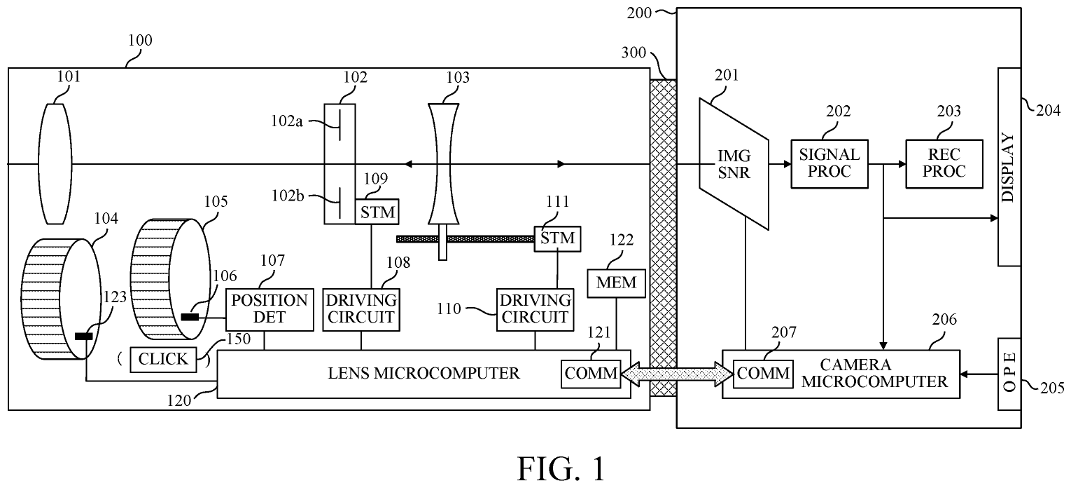

FIG. 1 illustrates the configuration of a camera system including a lens unit 100 as an optical apparatus (lens apparatus) that is commonly used according to Examples 1 to 4 described below, and a camera body 200 (image pickup apparatus) to which the lens unit 100 is detachably and communicatively attached. Each embodiment assumes a lens interchangeable type camera system, but two rounding resolutions in aperture control processing, which will be described below, may be applied to a lens integrated type camera as an optical apparatus.

The lens unit 100 has an imaging optical system. The imaging optical system includes a field lens 101, an aperture unit 102, and a focus lens 103 in order from the object side (left side in FIG. 1). The aperture unit 102 has a variable aperture diameter (in other words, aperture position) in order to adjust a light amount passing through the imaging optical system. The aperture position is a position that achieves a predetermined aperture index value (F-number or T-value). In the aperture unit 102, the aperture diameter is changed by driving the aperture blades 102a and 102b in the opening/closing direction by the driving force of the stepping motor 109. In the following description, driving the aperture blades 102a and 102b will be referred to as driving the aperture unit 102.

The focus lens 103 performs focusing of the imaging optical system by moving in the optical axis direction (arrow direction in FIG. 1). The focus lens 103 is held by a lens frame and a guide shaft (not illustrated) so as to be movable in the optical axis direction, and is driven in the optical axis direction by a driving force from a stepping motor 111.

The lens unit 100 has a lens microcomputer (referred to as lens microcomputer hereinafter) 120 as a lens control unit. The lens microcomputer 120 controls driving of the focus lens 103 and the aperture unit 102 according to user operations of the focus operation ring 104 and the aperture operation ring 105 as operation members provided in the lens unit 100. Stepping motors 111 and 109 are driven through driving circuits 110 and 108 according to commands from the lens microcomputer 120, respectively.

The lens microcomputer 120 also performs control according to various lens control commands transmitted from the camera body 200 (camera microcomputer 206 described below).

The lens microcomputer 120 recognizes an aperture position indicating positions of the aperture blades 102a and 102b in the opening/closing direction by integrating a driving amount of the stepping motor 109. The lens microcomputer 120 outputs an aperture control signal to the driving circuit 108 based on the aperture position. The driving circuit 108 drives the stepping motor 109 according to the aperture control signal.

Here, even if the aperture blades 102a and 102b are driven by designed values, the aperture unit 102 has an error in the aperture diameter due to error factors such as part accuracy and assembly error. In this embodiment, in a case where the stepping motor 109 is driven in micro steps, it is designed so that the aperture diameter changes by 1/16 steps each time the stepping motor 109 is driven by one step based on the 1-2 phase driving wave. In the following description, in a case where the driving amount of the stepping motor 109 is described in terms of the number of steps, it is the number of steps in terms of 1-2 phase driving waves unless otherwise specified.

In a case where the above error factors exist, even if the stepping motor 109 is driven by one step, a changing amount in the aperture diameter will not be exactly 1/16 steps, and the error depends on the driven positions of the aperture blades 102a and 102b. In order to deal with such an error, this embodiment stores a correction value for correcting the driving amount of the stepping motor 109 in the memory 122 for each aperture index value (Fno). Where INDEX 0 indicates a maximum aperture, the aperture index value is set from INDEX 0 to INDEX 15 from the maximum aperture to the minimum aperture every 1/32 steps ( 1/32 step units) so that the correction amount as the adjusting amount has a unit corresponding to 1/256 steps and stored in the memory 122. Actually projecting the observation light onto the image plane through the imaging optical system and evaluating the light amount reaching the image plane while the aperture diameter is changed from the maximum aperture to the minimum aperture can calculate the correction amount in changing the aperture diameter every 1/32 steps. Thereby, the aperture unit 102 according to this embodiment can form a highly accurate aperture diameter at each aperture index value every 1/32 steps from the maximum aperture.

The focus operation ring 104 is a rotatable operation member for a manual focus (MF) operation for inputting an instruction by the user to move the focus lens 103 to an arbitrary position. The direction and rotation amount of the focus operation ring 104 are detected by a focus rotation detector 123. The focus rotation detector 123 includes a photo-interrupter and a slit light shield plate that rotates between the light emitter and a light receiver of the photo-interrupter according to the rotation of the focus operation ring 104. The photo-interrupter outputs a pulsed signal by alternately arranged light transmitting portions and the light shielding portions of the slit light shield plate between the light emitter and the light receiver. The pulsed signal is input to the lens microcomputer 120. The lens microcomputer 120 detects the rotation amount of the focus operation ring 104 by counting the pulsed signal.

The focus rotation detector 123 includes a combination of two photo-interrupters spaced by a predetermined distance and a single slit light shield plate. The lens microcomputer 120 can determine the rotation direction of the focus operation ring 104 by determining which of the output pulse waveforms from the two photo-interrupters is faster.

The rotation speed of the focus operation ring 104 can be detected (calculated) by measuring the time from an edge portion where an output signal level of one photo-interrupter changes to the next edge portion of the output signal of the other photo-interrupter. However, in a case where the two photo-interrupters are not spaced as designed, the dimensional error appears as a time error between the edge portions, and the rotational speed cannot be accurately detected. Since no such problem occurs between the edge portions of the output signal of one photo-interrupter, the lens microcomputer 120 according to this embodiment determines the rotational speed of the focus operation ring 104 using the time intervals at which these edge portions appear.

The lens microcomputer 120 controls driving of the focus lens 103 in accordance with MF operation information (rotation direction, rotation amount, and rotation speed information) detected through the focus rotation detector 123 and a focus driving command transmitted from the camera microcomputer 206, which will be described below. Driving of the focus lens 103 is controlled by driving the stepping motor 111 via the driving circuit 110.

Although the focus rotation detector 123 includes the photo-interrupter in this embodiment, it may use a capacitive sensor, a magnetic sensor, or the like.

The aperture operation ring 105 is a rotatable operation member that performs an aperture operation for the user to input an instruction to set the aperture unit 102 to an arbitrary aperture index value. The aperture operation ring 105 can be rotated only within a movable range between two operation ends. The rotation direction, rotation amount, and rotation position (operating position) of the aperture operation ring 105 are detected by an aperture ring rotation detector 106 as a detector. The aperture ring rotation detector 106 includes a magnetic sensor, and detects the aperture ring position as an absolute rotation position within the movable range of the aperture operation ring 105.

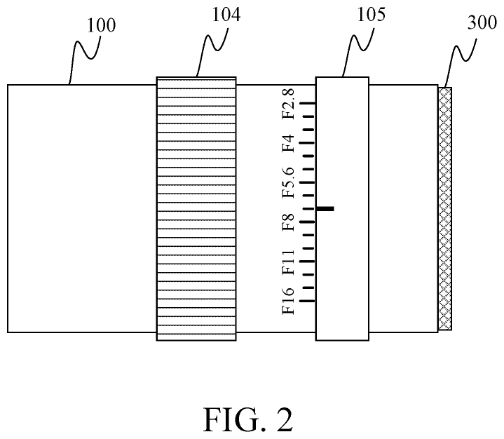

FIG. 2 illustrates the appearance around the aperture operation ring 105 in the lens unit 100. Fno as an aperture index value is written on the housing surface of the lens unit 100 near the aperture operation ring 105. In this embodiment, FIG. 2 illustrates the aperture index values Fno that increase every other step from the maximum aperture of F2.8 to the minimum aperture of F16 and an index line between the aperture index values corresponding to the ⅓ steps. The two operation ends of the aperture operation ring 105 are set to the maximum aperture (F2.8) and minimum aperture (F16).

An index line is marked at one location on the outer circumference portion of the aperture operation ring 105. The user rotates the aperture operation ring 105 so as to align the index line marked on the aperture operation ring 105 with the aperture index value on the housing side of the lens unit 100 using the index line as a guide.

The lens unit 100 according to this embodiment includes an unillustrated aperture ring switch. The aperture ring switch is operated by the user to instruct switching between the manual aperture mode and the automatic aperture mode. The manual aperture mode is a mode in which the aperture unit 102 is driven to a position corresponding to the aperture index value specified by operating the aperture operation ring 105. The automatic aperture mode is a mode in which an aperture index value can be specified under control from the camera body 200. The automatic aperture mode specifies an aperture index value determined mainly by auto-exposure (AE) control or an aperture index value specified by the user through a menu in the camera body 200. A description will now be given of aperture control in the manual aperture mode unless otherwise specified.

The lens unit 100 stores in the memory 122 aperture ring detection value information for associating a relationship between the aperture ring position (detection value) detected by the aperture ring rotation detector 106 and the position of each aperture index value on the housing surface. This aperture ring detection value information enables the corresponding aperture index value to be calculated from the rotation position (aperture ring position) detected by the aperture ring rotation detector 106 in a case where the aperture operation ring 105 is operated.

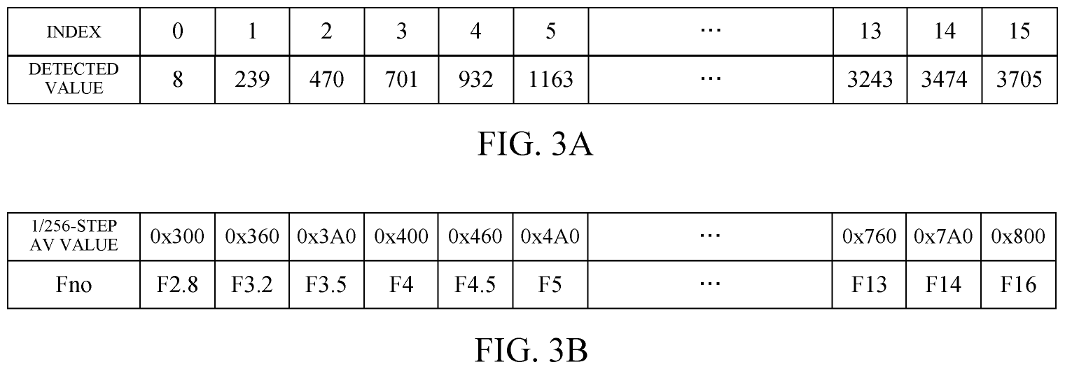

FIGS. 3A and 3B illustrate data structure of aperture ring detection value information. FIG. 3A illustrates the body of the aperture ring detection value information stored in the memory 122. The upper row illustrates INDEX 0 to INDEX 15, and the lower row illustrates the aperture ring position (detection value) corresponding to each of INDEX 0 to INDEX 15. FIG. 3B illustrates an aperture value (AV) value (upper stage) and Fno (lower stage) in the unit of 1/256 steps associated with INDEX 0 to INDEX 15 in FIG. 3A. The AV value in the unit of 1/256 steps will be referred to as 1/256-step AV value in the following description.

As illustrated in FIGS. 3A and 3B, the aperture ring detection value information has 16 data from INDEX 0 to INDEX 15, and FIGS. 3A and 3B illustrate a detected value by the aperture ring rotation detector 106 for each aperture index value in the unit of ⅓ steps from the maximum aperture F2.8 to the minimum aperture of F16. These detected values are obtained by actually operating the aperture operation ring 105 to each aperture index value position in manufacturing the lens unit 100, and are stored in the memory 122.

For example, a description will now be given of a detected value of 501 that is detected by the aperture ring rotation detector 106. For the detected value of 501, referring to FIG. 3A, the aperture index value corresponds to an aperture value between F3.5 and F4. Since the detected value at F3.5 is 470 and the detected value at F4 is 701, the detected value of 231 corresponds to ⅓ steps. Therefore, the aperture position corresponding to the detected value of 501 is a position that is narrowed down by a detected value of 31 from F3.5. At this time, since ⅓ steps of the 1/256-step AV value corresponds to 0x60, a position narrowed down by 31/231 is a position narrowed down by 0xC as the 1/256-step AV value. Thus, the aperture position corresponding to the detected value of 501 is 0x3AD, which is a position where the aperture is narrowed down by 0xD from 0x3A0 at the 1/256-step AV value according to the ratio calculation, that is, around F3.575.

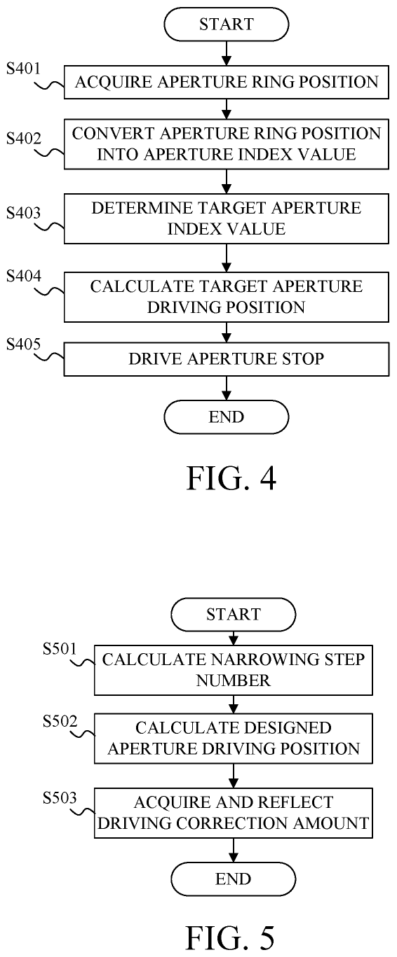

A flowchart in FIG. 4 illustrates basic aperture control processing executed by the lens microcomputer 120. The lens microcomputer 120 executes this processing in accordance with a computer program that is activated at regular intervals (here, 1 msec as an example). S stands for the step.

The current processing starts 1 msec after the previous processing. First, in S401, the lens microcomputer 120 acquires a detected value from the aperture ring rotation detector 106 as the current rotation position (aperture ring position) of the aperture operation ring 105.

Next, in S402, the lens microcomputer 120 as a specifying unit performs processing for converting a detected value acquired from the aperture ring rotation detector 106 into an aperture index value (specified aperture value: referred to as current aperture index value hereinafter).

Next, in S403, the lens microcomputer 120 determines (generates) a target aperture index value as a target aperture value of the aperture unit 102 from the current aperture index value. This processing will be described below.

Next, in S404, the lens microcomputer 120 calculates the driving amount of the stepping motor 109 for driving the aperture unit 102 from the aperture value corresponding to the current aperture index value to the aperture value corresponding to the target aperture index value determined in S404 (that is, is the target aperture driving position of the aperture unit 102).

A flowchart in FIG. 5 illustrates the details of the processing of S404. First, in S501, the lens microcomputer 120 calculates the narrowing step number by subtracting the maximum aperture index value as a designed value from the target aperture index value determined in S403.

Next, in S502, the lens microcomputer 120 calculates a designed aperture driving position.

Next, in S503, the lens microcomputer 120 acquires a driving correction amount. As described above, in this embodiment, the memory 122 stores a correction value in the unit of 1/256 steps for correcting the driving amount of the aperture unit 102 (stepping motor 109) in the unit of 1/32 steps from the maximum aperture. The lens microcomputer 120 normalizes the narrowed step number calculated in S501 in the unit of 1/32 steps (obtains the unit number in calculating how many units to be narrowed in the unit of 1/32 steps), thereby determining the driving correction amount. Then, the lens microcomputer 120 adds the driving correction amount thus determined to the narrowed step number calculated in S501 to calculate the corrected driving amount of the stepping motor 109.

In S405 of FIG. 4, the lens microcomputer 120 drives the stepping motor 109 by the corrected driving amount via the (aperture) driving circuit 108 so as to drive the aperture unit 102 to the target aperture driving position calculated in S404.

Repeating the above processing at 1 msec intervals can control the aperture diameter of the aperture unit 102 so as to follow the operation of the aperture operation ring 105 at 1 msec intervals. At this time, the follow-up control of the aperture unit 102 can be realized while the target aperture driving position is sequentially updated at a cycle of 1 msec by designing the computer program such that the current aperture diameter control can be started even if the aperture diameter control of the aperture unit 102 started in the previous processing is not completed.

The camera body 200 includes an image sensor 201 such as a CCD sensor or CMOS sensor that captures (photoelectrically converts) an object image formed by the lens unit 100. The camera body 200 further includes a signal processing unit 202, a recording processing unit 203, a camera microcomputer (referred to as a camera microcomputer hereinafter) 206 as a camera control unit, and a display unit 204.

The image sensor 201 photoelectrically converts an object image and outputs an electric signal (analog signal). This analog signal is converted into a digital signal by an unillustrated A/D conversion circuit, and a digital signal is input into the signal processing unit 202. The signal processing unit 202 performs various kinds of signal processing for the input digital signal to generate a focus signal representing a focus state of the imaging optical system (object image) and a luminance signal representing the exposure state to generate a video signal. The video signal generated by the signal processing unit 202 is sent to the recording processing unit 203, and still image data and moving image data obtained from the video signal are recorded in an unillustrated recording medium or the like. At this time, the digital signal as image pickup information input to the signal processing unit 202 is also used as a photometric evaluation value, and control is performed so that proper exposure is obtained by the auto-exposure control. More specifically, a proper relationship among the current aperture index value acquired by querying the lens microcomputer 120, the shutter speed setting stored in the camera microcomputer 206, and the sensor sensitivity setting is calculated so that the photometry evaluation value is a proper exposure. This embodiment can adjust the shutter speed setting and sensor sensitivity setting with a resolution in the unit of 1/128 steps.

The camera body 200 and the lens unit 100 are mechanically and electrically connected by a mount 300 as a joint. The lens unit 100 receives power supply from the camera body 200 via a power terminal unit provided on the mount 300. The camera microcomputer 206 and the lens microcomputer 120 communicate with each other via a communication terminal unit provided on the mount 300. The camera microcomputer 206 transmits an aperture driving command and a focus driving command to the lens microcomputer 120.

An operation unit 205 is an input interface provided on the camera body 200, and includes an imaging instruction switch, a camera setting switch, and the like. A camera microcomputer 206 controls the camera body 200 according to input from the operation unit 205.

### Example 1

A description will now be given of Example 1. A description will now be given of aperture control processing (aperture control method) according to this example and Examples 2 to 4 described below, in a case where the lens microcomputer 120 can select a rounding resolution to calculate (generate) the target aperture index value from the current aperture index value according to the operation of the aperture operation ring 105. The aperture control processing according to each example is characterized by the processing executed in S403 in the flowchart of FIG. 4.

In S402 described above, the detected value from the aperture ring rotation detector 106 is converted into the current aperture index value with a 1/256-step AV value ( 1/256-step resolution). This example converts the AV value obtained by rounding the current aperture index value (specified aperture value) with a specific rounding resolution into a target aperture index value (target aperture value) that is actually used. This embodiment can specify the specific rounding resolution from the camera body 200 (camera microcomputer 206).

The rounding resolution is a value that indicates a change amount in the target aperture value against a change amount in the unit of 1/256 steps of the current aperture index value. The rounding resolution in the unit of 1/256 steps, which will be described below, means that the target aperture value changes by 1/256 steps when a change amount in the current aperture index value reaches 1/256 steps. The rounding resolution in the unit of 1/32 steps, which will be described below, means that the target aperture value changes by 1/32 steps when a change amount in the current aperture index value reaches 1/256 steps×8.

The camera microcomputer 206 specifies the rounding resolution to the lens microcomputer 120 by command communication via the mount 300. The camera microcomputer 206 can specify the rounding resolution to the lens microcomputer 120 at any time. At this time, by specifying a rounding resolution (first resolution) in the unit of 1/32 steps corresponding to the unit step (correction resolution) of the correction value for the aperture unit 102, the aperture unit 102 can be controlled to achieve high accuracy of the aperture diameter and high reproducibility of a target aperture index value. At this time, the auto-exposure control is controlled with a resolution of 1/128 steps for both the shutter speed setting and the sensor sensitivity setting, so setting the target aperture index value with a rougher (lower) rounding resolution of 1/32 steps can reduce the residual error in the auto-exposure control. The processing of generating the target aperture index value with a rounding resolution of 1/32nd step is first processing.

Aside from this, the camera microcomputer 206 can set a rounding resolution (second resolution) in the unit of 1/256 steps described with reference to FIGS. 3A and 3B to the lens microcomputer 120. Thereby, an aperture diameter of the aperture unit 102 is more smoothly changed against the operation of the aperture operation ring 105 than using a rounding resolution of 1/32 steps. The processing of generating the target aperture index value with a rounding resolution of 1/256 steps is second processing.

As described above, this example can select a rounding resolution between the first resolution and the second resolution according to the specification from the camera body 200. The selectable rounding resolution and correction resolution of the aperture unit 102 may be stored as designed values in a state previously programmed in the camera microcomputer 206, or may be notified from the lens microcomputer 120 to the camera microcomputer 206 by command communication.

In a case where it is to increase the accuracy of auto-exposure control, such as still image capturing, this example sets an accuracy priority rounding resolution (first resolution) corresponding to the correction resolution of the aperture unit 102 and can perform highly accurate auto-exposure control with a reduced residual error. On the other hand, in a case where priority is given to a smooth follow-up change of the aperture value against the operation of the aperture operation ring 105 rather than the accuracy of the aperture value (aperture diameter) as in moving image capturing, this example sets a follow-up priority rounding resolution (second resolution) finer than the correction resolution. Thereby, this example can acquire a natural moving image in which sudden luminance changes can be suppressed.

### Example 2

A description will now be given of Example 2. This example selects the rounding resolution according to the aperture control mode set in the camera body 200.

In this example, the lens unit 100 has two aperture control methods for controlling the aperture unit 102 against the operation of the aperture operation ring 105. The camera microcomputer 206 can specify one of the two aperture control methods, the first method and the second method, to the lens microcomputer 120 at any time by command communication. The lens microcomputer 120 performs the first processing in a case where the first method is specified, and performs the second processing in a case where the second method is specified.

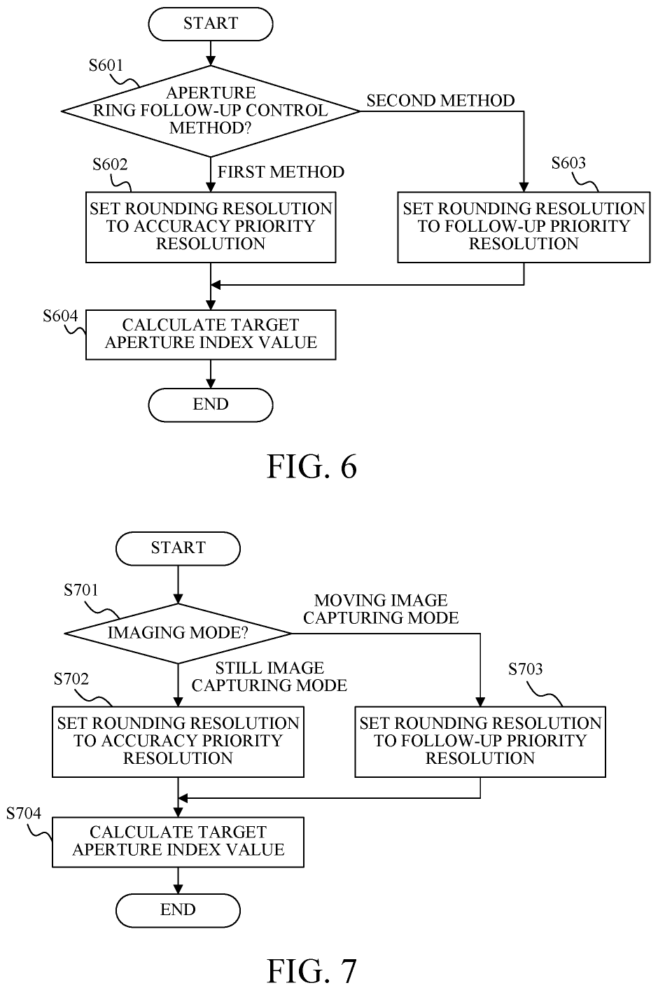

A flowchart of FIG. 6 illustrates the processing executed in S403 of FIG. 4 in this example. First, in S601, the lens microcomputer 120 confirms the aperture control method specified by the camera microcomputer 206. In a case where the designated aperture control method is the first method, the flow proceeds to S602 and the lens microcomputer 120 sets the rounding resolution to the accuracy priority rounding resolution (first resolution) corresponding to the correction resolution (the unit of 1/32 steps) of the aperture unit 102.

On the other hand, in a case where the specified aperture control method is the second method, the flow proceeds to S603, and the lens microcomputer 120 sets the rounding resolution to the follow-up priority rounding resolution (second resolution) with the unit of 1/256 steps finer than that of the accuracy priority resolution.

Next, in S604, the lens microcomputer 120 calculates a target aperture index value using the rounding resolution set in S602 or S603.

In a case where the first method is specified as the aperture control method in the camera body 200, this example provides high accuracy auto-exposure control that reduces the residual error by setting the accuracy priority rounding resolution corresponding to the correction resolution of the aperture unit 102. On the other hand, in a case where the second method is specified, this example sets the follow-up priority rounding resolution finer than the correction resolution. Thereby, this example can acquire obtain a natural moving image in which sudden changes in luminance are suppressed.

### Example 3

A description will now be given of Example 3. This example selects a rounding resolution according to an imaging mode set in the camera body 200.

In this example, the lens microcomputer 120 can acquire the imaging mode currently set in the camera body 200 from the camera microcomputer 206 through command communication.

A flowchart of FIG. 7 illustrates the processing executed in S403 of FIG. 4 in this example. First, in S701, the lens microcomputer 120 confirms the imaging mode currently set in the camera body 200. In a case where the set imaging mode is a still image imaging mode, the flow proceeds to S702 and the lens microcomputer 120 sets a rounding resolution to an accuracy priority rounding resolution (first resolution) corresponding to the correction resolution (the unit of 1/32 step) of the aperture unit 102 based on the lens microcomputer 120's determination.

On the other hand, in a case where the imaging mode is a moving image imaging mode, the flow proceeds to S703 and the lens microcomputer 120 sets a rounding resolution to a follow-up priority rounding resolution (second resolution) in the unit of 1/256 steps, which is finer than the accuracy priority resolution, based on the lens microcomputer 120's determination.

Next, in S704, the lens microcomputer 120 calculates the target aperture index value using the rounding resolution set in S702 or S703.

In a case where the still image capturing mode is set to the camera body 200, this example sets the accuracy priority rounding resolution corresponding to the correction resolution of the aperture unit 102 and acquires a highly accurate auto-exposure control with a reduced residual error. On the other hand, in a case where the moving image capturing mode is set to the camera body 200, this example sets the follow-up priority rounding resolution finer than the correction resolution. Thereby, this example can acquire a natural moving image in which sudden changes in luminance are suppressed.

### Example 4

A description will now be given of Example 4. This example selects a rounding resolution according to the presence or absence of a click function for rotating the aperture operation ring 105. A click mechanism (click unit) 150 illustrated in parentheses in FIG. 1 mechanically or electrically generates a click sense for each predetermined operation amount of the aperture operation ring 105. The click mechanism 150 according to this example can switch between presence (turning-on or validity) and absence (turning-off or invalidity) of the click function for the rotation operation of the aperture operation ring 105. For example, by sliding the aperture operation ring 105 in the optical axis direction relative to the housing of the lens unit 100, the click function can be switched between the presence and the absence. The lens unit 100 has a sensor configured to detect the slide position of the aperture operation ring 105 in the optical axis direction, that is, whether the click function is turned on or off.

The lens microcomputer 120 can acquire the rounding resolution (in the unit of ½ steps, ⅓ steps, or the like) for calculating the aperture index value from the camera microcomputer 206 by command communication.

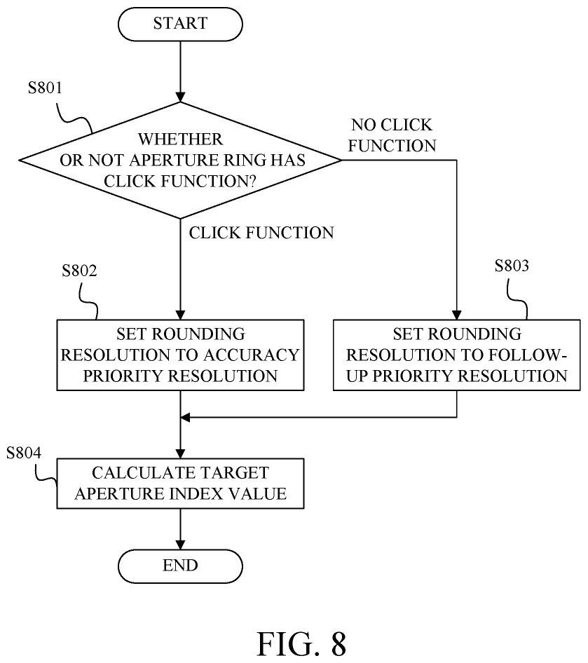

A flowchart of FIG. 8 illustrates the processing executed in S403 of FIG. 4 in this example. First, in S801, the lens microcomputer 120 checks whether the aperture operation ring 105 has the click function. In a case where the click mechanism exists, the flow proceeds to S802 to set the rounding resolution to the accuracy priority rounding resolution (first resolution). The accuracy priority rounding resolution at this time is set in the unit of ½ steps, ⅓ steps, or the like acquired from the camera microcomputer 206.

On the other hand, if there is no click function, the flow proceeds to S803 and the lens microcomputer 120 sets the rounding resolution to a follow-up priority rounding resolution (second resolution) in the unit of 1/256 steps, which is finer than the accuracy priority resolution.

Next, in S804, the lens microcomputer 120 calculates a target aperture index value using the rounding resolution set in S702 or S703.

In a case where the lens unit 100 has a click function for the aperture operation ring 105, this example can acquire highly accurate auto-exposure control with a reduced residual error by setting the accuracy priority rounding resolution corresponding to the correction resolution of the aperture unit 102. On the other hand, in a case where there is no click function and the moving image capturing mode is set, this example sets a follow-up priority rounding resolution that is finer than the correction resolution. Thereby, this example can acquire a natural moving image in which sudden changes in luminance are suppressed.

Although Fno is used as the aperture index value in each example, an effective aperture value Tno, which takes into consideration the light transmittance of the imaging optical system, may be used as the aperture index value.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This embodiment can accurately or smoothly control an aperture value (F-number) according to an operation of an operation member in an optical apparatus having an aperture unit.

This application claims the benefit of Japanese Patent Application No. 2022-173158, filed on Oct. 28, 2022, hereby incorporated by reference herein in its entirety.

What is claimed is:

1. An optical apparatus comprising:
an aperture unit having a variable aperture value;
an operation member operable by a user and configured to set the aperture value; and
a processor configured to:
output a specified aperture value according to an operation of the operation member,
generate a target aperture value from the specified aperture value, and
control driving of the aperture unit based on the target aperture value,
wherein the processor performs one of first processing for generating the target aperture value with a first resolution from the specified aperture value, and second processing for generating the target aperture value with a second resolution, which is finer than the first resolution, from the specified aperture value.

2. The optical apparatus according to claim 1, wherein the processor is configured to drive the aperture unit with a driving amount obtained using the target aperture value of the first resolution generated in the first processing and a correction value provided in a unit corresponding to the second resolution.

3. The optical apparatus according to claim 1, wherein the optical apparatus is attachable to and detachable from an image pickup apparatus, and
wherein the processor is configured to perform one of the first processing and second processing which corresponds to one of the first resolution and the second resolution specified by the image pickup apparatus.

4. The optical apparatus according to claim 1, wherein the optical apparatus is attachable to and detachable from an image pickup apparatus, and
wherein the processor is configured to perform one of the first processing and the second processing which corresponds to an aperture control method specified by the image pickup apparatus.

5. The optical apparatus according to claim 1, wherein the optical apparatus is attachable to and detachable from an image pickup apparatus, and
wherein the processor is configured to perform one of the first processing and the second processing according to an imaging mode set in the image pickup apparatus.

6. The optical apparatus according to claim 1, further comprising a click unit configured to generate a click sense for each predetermined operation amount of the operation member,
wherein the click unit is configured to switch between presence or absence of the click sense, and
wherein the processor is configured to perform one of the first processing and the second processing according to the presence or absence of the click sense.

7. A control method of an optical apparatus that includes an aperture unit having a variable aperture value, and an operation member operable by a user and configured to set the aperture value, the control method comprising the steps of:
outputting a specified aperture value according to an operation of the operation member;
generating a target aperture value from the specified aperture value; and
controlling driving of the aperture unit based on the target aperture value,
wherein the controlling step performs one of first processing for generating the target aperture value with a first resolution from the specified aperture value, and second processing for generating the target aperture value with a second resolution, which is finer than the first resolution, from the specified aperture value.

8. A non-transitory computer-readable storage medium storing a program that causes a computer to execute the control method described according to claim 7.
